(19) United States
(12) Patent Application Publication
(10) Pub. No.: US 2026/0203834 A1
(43) Pub. Date: Jul. 16, 2026

(54) SYSTEMS AND METHODS FOR CONSTRAINT-BASED MODIFICATION OF ELECTRONIC HEALTHCARE CLAIM DATA TO INFLUENCE ADJUDICATION BEHAVIOR

(71) Applicant: Mark Niemeyer, Ofallon, MO (US)

(72) Inventor: Mark Niemeyer, Ofallon, MO (US)

(73) Assignee: SavePx, Inc., Ofallon, MO (US)

(21) Appl. No.: 19/438,453

(22) Filed: Dec. 31, 2025

Related U.S. Application Data
(60) Provisional application No. 63/744,077, filed on Jan. 10, 2025.

(51) Int. Cl. G06Q 40/08

(52) U.S. Cl. CPC G06Q 40/084

(57) ABSTRACT

Systems and methods are disclosed for evaluating electronic healthcare claim data against pre-established service access constraints and modifying claim data elements to influence adjudication behavior within claims adjudication systems. A computer-implemented system receives electronic claim data corresponding to healthcare services rendered to an individual and evaluates the claim data against service access constraints defining conditions under which the individual is treated as having satisfied a financial responsibility requirement for at least a portion of the healthcare services. The system classifies the electronic claim data as satisfying or not satisfying the service access constraints. When the claim data satisfies the service access constraints, the system generates adjudication control information and modifies one or more claim data elements interpreted by a claims adjudication system to determine adjudication behavior. The electronic claim data, including any modified claim data elements, is transmitted to the claims adjudication system for adjudication. Non-satisfying claims omit control information.

### CROSS-REFERENCE TO RELATED APPLICATIONS

This application claims the benefit of priority under 35 U.S.C. § 119(e) to U.S. Provisional Patent Application No. 63/744,077 , filed Jan. 10, 2025, entitled “Marketplace of Bundled Services Derived from Primary Insurance Contracted Networks,” the entire contents of which are hereby incorporated by reference herein in their entirety for all purposes.

### TECHNICAL FIELD

The present disclosure relates to healthcare information systems and, more specifically, to computer-implemented systems and methods for evaluating electronic healthcare claim data against pre-established service access constraints and modifying claim data elements to influence adjudication behavior within payer systems in the United States healthcare claims ecosystem.

### BACKGROUND

The United States healthcare claims ecosystem is a vast, interconnected network of provider systems, clearinghouses, and payer adjudication engines that collectively process billions of electronic claims each year. Although this infrastructure has evolved over decades, its core architecture remains rooted in assumptions established long before the emergence of prepaid access models, consumer-directed healthcare, digital platforms, or alternative payment arrangements. As a result, the system is structurally optimized for a model in which healthcare services are delivered first and adjudicated later, with financial responsibility determined retrospectively through payer-defined cost-sharing rules.

Electronic claim data in the United States is primarily transmitted using standardized formats such as ANSI X12 837 Professional and Institutional transactions. These formats are designed to convey information about services rendered, provider identifiers, procedure codes, diagnosis codes, service dates, and other data elements required for adjudication. The standards assume that payer systems will apply deductibles, copayments, coinsurance, contracted rates, and benefit limitations using internal reimbursement parameters. The architecture does not provide a standardized mechanism for expressing that an individual has already satisfied a financial responsibility requirement through a pre-established arrangement outside of the payer's benefit design.

Clearinghouses serve as intermediaries that validate, normalize, and route electronic claim data between provider systems and payer adjudication systems. Their functions are largely administrative and technical, including syntax validation, payer-specific routing, and acknowledgment handling. Clearinghouses do not evaluate financial responsibility conditions and do not modify claim data in ways intended to influence payer adjudication behavior based on pre-established service access constraints.

Payer adjudication systems apply complex benefit logic to determine reimbursement outcomes. These systems evaluate claim data against eligibility files, provider contracts, coverage rules, and cost-sharing parameters defined by insurance plans. Payer adjudication systems assume that financial responsibility is determined exclusively by the payer's benefit design unless claim data is presented in a manner interpreted by the adjudication system to alter adjudication behavior and that any deviation from standard cost-sharing must be handled through payer-specific mechanisms such as prior authorizations, network exceptions, or internal overrides.

As new healthcare access models emerge, including prepaid services, employer-sponsored service access programs, and other alternative arrangements, providers increasingly deliver services for which an individual's financial responsibility has been satisfied prior to claim adjudication. However, when claims for such services are submitted, payer systems lack a technical mechanism to recognize these conditions. As a result, claims are adjudicated as if no pre-established financial responsibility satisfaction exists, leading to incorrect patient billing, provider write-offs, administrative rework, and inconsistent outcomes.

Attempts to signal such arrangements using existing claim data elements, such as modifiers or supplemental segments, without a standardized mechanism for evaluating service access conditions and conditionally generating adjudication control information, are inconsistent and unreliable. Clearinghouses typically pass these elements without interpretation, and payer systems often ignore or override them unless they align with established payer workflows. Manual exception handling does not scale and introduces operational risk.

Accordingly, the existing claims ecosystem lacks an interoperable, deterministic mechanism for evaluating electronic claim data against pre-established service access conditions and influencing adjudication behavior without modifying payer adjudication systems themselves.

### SUMMARY

The systems and methods described in this disclosure introduce a technical processing layer that enables electronic healthcare claim data to be evaluated against pre-established service access constraints and modified in ways that influence adjudication behavior within payer claims adjudication systems. This processing layer operates independently of provider systems, clearinghouses, and payer adjudication systems, and does not require modification of existing adjudication logic or reimbursement parameters maintained by payers.

In one aspect, a computer-implemented system receives electronic claim data corresponding to healthcare services rendered to an individual. The electronic claim data may include claim-level and line-level data elements generated by a healthcare service provider computing system using standardized claim formats. The system evaluates the electronic claim data against a set of service access constraints associated with the individual. The service access constraints define conditions under which the individual is treated as having satisfied a financial responsibility requirement for at least a portion of the healthcare services prior to claim adjudication.

The system classifies the electronic claim data as satisfying or not satisfying the service access constraints. When the electronic claim data satisfies the service access constraints, the system generates adjudication control information that, when processed by a claims adjudication system distinct from the computer-implemented system, causes the claims adjudication system to adjudicate the claim without applying one or more patient-responsibility cost-sharing rules. The system modifies one or more claim data elements associated with the electronic claim data based on the adjudication control information. The modified claim data elements are of a type interpreted by claims adjudication systems to determine adjudication behavior.

The system transmits the electronic claim data, including the modified claim data elements, to the claims adjudication system for adjudication using reimbursement parameters maintained by the claims adjudication system. When the electronic claim data does not satisfy the service access constraints, the system transmits the electronic claim data without the adjudication control information, allowing the claims adjudication system to adjudicate the claim according to standard benefit logic.

The disclosed systems and methods enable deterministic adjudication outcomes for claims associated with pre-established service access conditions while preserving compatibility with existing healthcare claims infrastructure. By influencing adjudication behavior through modification of claim data elements already interpreted by payer systems, the disclosed technology integrates pre-established financial responsibility satisfaction into standard claims workflows without requiring changes to payer adjudication engines.

### BRIEF DESCRIPTION OF THE DRAWINGS

The drawings referenced throughout this disclosure illustrate example embodiments of the systems and methods described herein. The drawings are provided to explain the principles of the disclosed technology and are not intended to limit the scope of the claims.

FIG. 1 illustrates a system architecture in which a computer-implemented constraint evaluation and claim modification system operates between a healthcare service provider computing system and a claims adjudication system.

FIG. 2 illustrates a claim-aligned functional processing pipeline performed by the computer-implemented constraint evaluation and claim modification system.

FIG. 3 illustrates example data structures supporting constraint evaluation and claim modification.

### DETAILED DESCRIPTION

The following detailed description provides a comprehensive explanation of the systems and methods introduced in this disclosure. The description conveys the technical architecture, operational flows, and data relationships that enable electronic healthcare claim data to be evaluated against pre-established service access constraints and modified to influence adjudication behavior within claims adjudication systems using claim data elements already interpreted by such systems. The embodiments described herein are illustrative and not limiting, and variations, extensions, and alternative implementations may be used without departing from the scope of the claims.

The disclosed technology is designed to operate within the existing United States healthcare claims ecosystem, which includes provider computing systems, clearinghouses, and payer claims adjudication systems. The system does not require modification of these existing components. Instead, it introduces an independent processing layer that evaluates claim data, applies constraint logic, generates adjudication control information, and modifies claim data elements in a manner that payer adjudication systems already interpret as part of standard adjudication workflows.

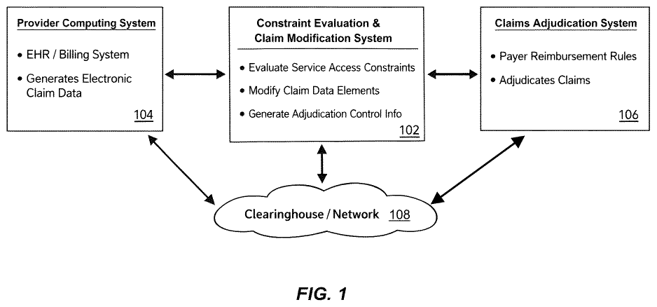

### 1. System Overview (FIG. 1)

FIG. 1 illustrates an example system environment 100 in which a constraint evaluation and claim modification system 102 operates between a healthcare service provider computing system 104 and a claims adjudication system 106.

The healthcare service provider computing system 104 may include electronic health record (EHR) systems, practice management systems, billing systems, or other software platforms used by healthcare providers to document services and generate electronic claim data. The provider computing system generates electronic claim data corresponding to healthcare services rendered to an individual, typically using standardized claim formats such as ANSI X12 837 transactions.

The constraint evaluation and claim modification system 102 receives the electronic claim data prior to adjudication. The system 102 operates independently of the claims adjudication system 106 and does not perform claim adjudication. Instead, the system 102 evaluates the electronic claim data against service access constraints associated with the individual and conditionally modifies claim data elements to influence adjudication behavior within the claims adjudication system 106.

The claims adjudication system 106 applies reimbursement parameters maintained by the payer, including benefit rules, contracted rates, and cost-sharing logic. The claims adjudication system 106 interprets claim data elements using existing adjudication logic. The disclosed system influences adjudication behavior solely through modification of claim data elements and does not require changes to the adjudication system's internal logic or configuration.

Electronic claim data may be transmitted from the healthcare service provider computing system 104 to the constraint evaluation and claim modification system 102 directly or through one or more intermediary systems, such as a clearinghouse or network 108. Likewise, the constraint evaluation and claim modification system 102 may transmit modified or unmodified electronic claim data to the claims adjudication system 106 directly or through the clearinghouse or network 108. The clearinghouse or network 108, when present, may perform validation, formatting, or routing functions and does not evaluate service access constraints or perform claims adjudication. The specific transmission path and presence of the clearinghouse or network 108 are not limiting.

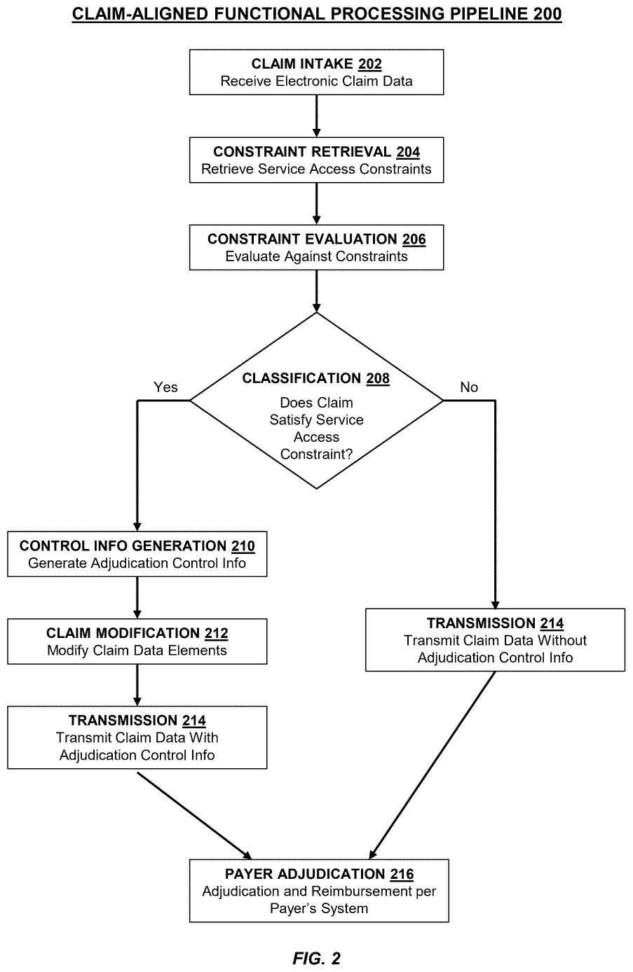

### 2. Claim-Aligned Functional Architecture (FIG. 2)

FIG. 2 illustrates an example functional processing pipeline 200 performed by the constraint evaluation and claim modification system.

The pipeline begins with a claim intake operation 202, in which the system receives electronic claim data corresponding to healthcare services rendered to an individual. The electronic claim data may include claim-level data elements, line-level data elements, and supplemental data elements.

A constraint retrieval operation 204 retrieves service access constraints associated with the individual. The service access constraints may be retrieved based on identifiers included in the electronic claim data, such as patient identifiers, member identifiers, access identifiers, provider identifiers, procedure codes, or other metadata.

A constraint evaluation operation 206 evaluates the electronic claim data against the retrieved service access constraints. The evaluation may include verifying that the submitting provider is eligible, verifying that the billed healthcare service is eligible, verifying that the service date falls within a validity period, and verifying that utilization limits or other conditions have been satisfied.

A classification operation 208 classifies the electronic claim data as satisfying or not satisfying the service access constraints. This classification determines whether adjudication control information will be generated and applied to the claim data.

When the claim data satisfies the service access constraints, an adjudication control information generation operation 210 generates adjudication control information. The adjudication control information is structured to cause a claims adjudication system to adjudicate the claim without applying one or more patient-responsibility cost-sharing rules when the information is processed by the claims adjudication system.

A claim modification operation 212 modifies one or more claim data elements based on the adjudication control information. The modified claim data elements are of a type interpreted by claims adjudication systems to determine adjudication behavior.

A transmission operation 214 transmits the electronic claim data, including any modified claim data elements, to the claims adjudication system for adjudication using reimbursement parameters maintained by the claims adjudication system. When the claim data does not satisfy the service access constraints, the system transmits the claim data without adjudication control information.

A payer adjudication operation 216 is performed by the claims adjudication system, which is distinct from the constraint evaluation and claim modification system. In operation 216, the claims adjudication system processes the electronic claim data using existing adjudication logic, benefit rules, and contracted reimbursement parameters. When adjudication control information is present, the claims adjudication system interprets the modified claim data elements to adjudicate the claim without applying one or more patient-responsibility cost-sharing rules. When adjudication control information is absent, the claims adjudication system adjudicates the claim using standard benefit and cost-sharing logic.

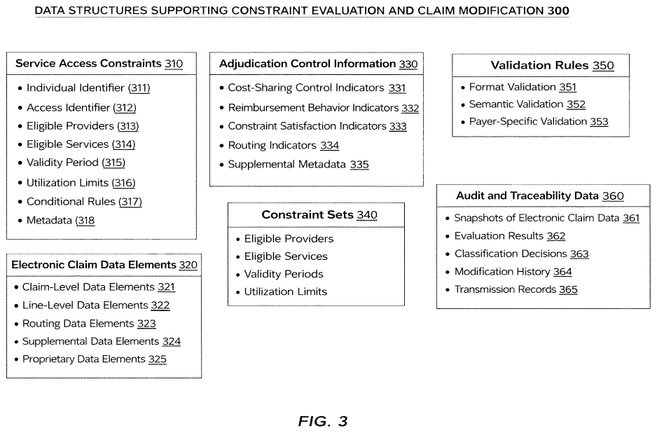

### 3. Data Structures Supporting Constraint Evaluation and Claim Modification (FIG. 3)

FIG. 3 illustrates example data structures 300 used by the constraint evaluation and claim modification system to evaluate electronic healthcare claim data, determine whether the claim data satisfies pre-established service access constraints, generate adjudication control information, and modify claim data elements in ways that influence adjudication behavior within claims adjudication systems.

The data structures described herein are representative and not limiting. The system may use alternative formats, schemas, or representations depending on implementation requirements, payer specifications, or integration constraints. The data structures may be represented using relational database schemas, JSON documents, XML documents, HL7 FHIR resources, proprietary formats, in-memory objects, or distributed key-value stores. The system may convert between formats as needed to support interoperability with provider systems, clearinghouses, and claims adjudication systems.

### 3.1 Service Access Constraints (310)

Service access constraints 310 define conditions under which an individual is treated as having satisfied a financial responsibility requirement for one or more healthcare services. The service access constraints 310 may originate from pre-established arrangements, benefit configurations, or other service access conditions defined prior to claim adjudication.

The service access constraints 310 may include one or more of the following elements.

### 3.1.1 Individual Identifier (311)

An individual identifier 311 associated with the individual to whom the service access constraints apply. The identifier may include a patient identifier, member identifier, subscriber identifier, system-generated identifier, or a hashed or tokenized representation thereof.

### 3.1.2 Access Identifier (312)

An access identifier 312 that links electronic claim data to a specific set of service access constraints. The access identifier may be generated by the system, derived from external systems, encoded, encrypted, hashed, alphanumeric, or otherwise structured to allow retrieval of the associated constraints during claim processing.

### 3.1.3 Eligible Providers (313)

One or more identifiers corresponding to healthcare service providers eligible under the service access constraints, shown as eligible providers 313. Provider identifiers may include National Provider Identifiers (NPIs), Tax Identification Numbers (TINs), internal provider identifiers, facility identifiers, or combinations thereof.

### 3.1.4 Eligible Services (314)

One or more healthcare services eligible under the service access constraints, shown as eligible services 314. Eligible services may be defined using procedure codes, such as CPT or HCPCS codes, revenue codes, diagnosis codes, service categories, or procedure groupings.

### 3.1.5 Validity Period (315)

A validity period 315 defining a time window during which the service access constraints apply. The validity period may include start dates, end dates, renewal rules, expiration conditions, or combinations thereof.

### 3.1.6 Utilization Limits (316)

Utilization limits 316 defining allowable usage of eligible healthcare services. Utilization limits may include visit counts, unit limits, service counts, frequency limits, or monetary thresholds.

### 3.1.7 Conditional Rules (317)

Conditional rules 317 defining additional requirements for satisfaction of the service access constraints. Conditional rules may include sequencing rules, prerequisite services, provider-specific conditions, or other rule-based criteria evaluated by the system.

### 3.1.8 Metadata (318)

Metadata 318 associated with the service access constraints, including creation timestamps, source system identifiers, version identifiers, and audit information.

### 3.2 Electronic Claim Data Elements (320)

Electronic claim data elements 320 represent fields, segments, and values included in electronic claim data submitted for adjudication. These data elements may be modified by the system to influence adjudication behavior.

Electronic claim data elements 320 may include:
claim-level data elements 321;
line-level data elements 322;
routing data elements 323;
supplemental data elements 324; and
proprietary data elements 325 interpreted by specific claims adjudication systems or clearinghouses.

### 3.3 Adjudication Control Information (330)

Adjudication control information 330 is generated by the system when electronic claim data satisfies service access constraints. The adjudication control information 330 instructs a claims adjudication system to apply specific adjudication behavior when the claim is processed.

Adjudication control information 330 may include:
cost-sharing control indicators 331;
reimbursement behavior indicators 332;
constraint satisfaction indicators 333;
routing indicators 334; and
supplemental metadata 335.

### 3.4 Constraint Sets (340)

A constraint set 340 represents a collection of service access constraints associated with an individual. A constraint set 340 may include multiple eligible providers, eligible services, validity periods, utilization limits, and conditional rules. Constraint sets may be static, dynamic, rule-based, time-based, or event-based.

### 3.5 Validation Rules (350)

Validation rules 350 define requirements for evaluating electronic claim data and service access constraints. Validation rules 350 may include:
format validation rules 351;
semantic validation rules 352; and
payer-specific validation rules 353.

Validation rules may be stored in rule engines, configuration files, databases, or machine-readable schemas.

### 3.6 Audit and Traceability Data (360)

Audit and traceability data 360 records system activity and supports compliance, debugging, reporting, and traceability.

Audit and traceability data 360 may include:
snapshots of electronic claim data 361;
constraint evaluation results 362;
classification decisions 363;
modification history 364; and
transmission records 365.

### EXAMPLES

The following examples illustrate how the disclosed systems and methods may operate in practice. These examples are provided for explanatory purposes only and are not intended to limit the scope of the claims. Variations, extensions, and alternative implementations may be used without departing from the principles described herein.

### Example 1: Pre-Established Access to a Preventive Healthcare Service

In this example, an individual has pre-established access to a preventive healthcare service under a set of service access constraints associated with the individual. The service access constraints define an eligible healthcare service provider, an eligible healthcare service, a validity period, and a utilization limit of one service.

### Service Delivery and Claim Submission

The individual receives the preventive healthcare service from the eligible healthcare service provider. The provider generates electronic claim data corresponding to the rendered service using a standardized claim format. The electronic claim data includes identifiers that allow retrieval of the associated service access constraints.

### Constraint Evaluation and Claim Processing

The constraint evaluation and claim modification system receives the electronic claim data and retrieves the service access constraints associated with the individual. The system evaluates the claim data against the constraints by verifying that the provider is eligible, the billed service is eligible, the service date falls within the validity period, and the utilization limit has not been exceeded.

Based on this evaluation, the system classifies the electronic claim data as satisfying the service access constraints.

### Claim Modification and Adjudication

The system generates adjudication control information instructing a claims adjudication system to bypass patient-responsibility cost-sharing rules. The system modifies one or more claim data elements based on the adjudication control information and transmits the modified claim data for adjudication.

The claims adjudication system processes the modified claim data using existing reimbursement parameters and adjudicates the claim without applying deductible, copayment, or coinsurance logic.

### Example 2: Employer-Sponsored Service Access

In this example, an employer establishes service access constraints for a set of healthcare services available to employees. The service access constraints specify a list of eligible healthcare service providers, a list of eligible healthcare services, a validity period, and a utilization limit.

### Claim Submission

An employee receives an eligible healthcare service from an eligible provider. The provider generates electronic claim data without explicitly including an access identifier. The constraint evaluation system identifies the applicable service access constraints using an individual identifier included in the claim data.

### Constraint Evaluation and Claim Processing

The system evaluates the electronic claim data against the retrieved service access constraints by verifying provider eligibility, service eligibility, service date validity, and utilization limits. The system classifies the claim data as satisfying the service access constraints.

### Claim Modification and Adjudication

The system generates adjudication control information and modifies one or more claim data elements prior to transmission. The modified claim data is adjudicated by the claims adjudication system using existing reimbursement parameters, resulting in adjudication without application of patient-responsibility cost-sharing rules.

### Example 3: Multiple Services With Conditional Eligibility

In this example, service access constraints define eligibility for multiple healthcare services subject to conditional rules. The constraints specify included services, excluded services, provider eligibility requirements, and utilization limits.

### Claim Submission and Evaluation

A healthcare service provider submits electronic claim data for a service included under the service access constraints. The constraint evaluation system retrieves the applicable constraint set and evaluates the claim data against the constraints, including conditional eligibility rules.

The system classifies the claim data as satisfying the service access constraints.

### Claim Modification and Adjudication

The system generates adjudication control information and modifies one or more claim data elements. The claims adjudication system processes the modified claim data using existing reimbursement parameters and adjudicates the claim without applying patient-responsibility cost-sharing rules.

### Example 4: Claim Data Not Satisfying Service Access Constraints

In this example, a healthcare service provider submits electronic claim data for a healthcare service that does not satisfy the applicable service access constraints.

### Constraint Evaluation

The constraint evaluation system retrieves the service access constraints and evaluates the claim data. The system determines that one or more conditions are not satisfied, such as provider ineligibility, service ineligibility, expiration of a validity period, or exceeding a utilization limit.

The system classifies the electronic claim data as not satisfying the service access constraints.

### Claim Transmission and Adjudication

Because the claim data does not satisfy the service access constraints, the system transmits the electronic claim data without adjudication control information that instructs the payer to bypass patient-responsibility cost-sharing rules

The claims adjudication system adjudicates the claim using standard benefit logic, including application of deductible, copayment, and coinsurance rules.

1. A computer-implemented system comprising one or more processors and memory storing instructions that, when executed by the one or more processors, cause the system to:
receive, from a computing system associated with an entity that provides healthcare services, electronic claim data corresponding to healthcare services rendered to an individual;
evaluate the electronic claim data against a set of pre-established service access constraints associated with the individual, the service access constraints defining conditions under which the individual is treated as having satisfied a financial responsibility requirement for at least a portion of the healthcare services;
classify the electronic claim data as satisfying or not satisfying the service access constraints;
in response to classifying the electronic claim data as satisfying the service access constraints, generate adjudication control information that, when processed by a claims adjudication system distinct from the computer-implemented system, causes the claims adjudication system to adjudicate the electronic claim data without applying one or more patient-responsibility cost-sharing rules;
modify one or more claim data elements associated with the electronic claim data based on the adjudication control information, the claim data elements being of a type used by the claims adjudication system to determine adjudication behavior; and
transmit the electronic claim data including the modified claim data elements to the claims adjudication system for adjudication using reimbursement parameters maintained by the claims adjudication system, and, in response to classifying the electronic claim data as not satisfying the service access constraints, transmit the electronic claim data without adjudication control information that instructs the claims adjudication system to bypass patient-responsibility cost-sharing rules.

2. The system of claim 1, wherein the service access constraints correspond to prepaid access to healthcare services selected prior to delivery of the healthcare services.

3. The system of claim 1, wherein the service access constraints specify one or more eligible healthcare service providers, one or more eligible healthcare services or procedure codes, and a validity period defining a time window during which the electronic claim data is eligible for adjudication without patient-responsibility cost-sharing.

4. The system of claim 1, wherein the service access constraints are associated with an access identifier included in the electronic claim data.

5. The system of claim 4, wherein the access identifier comprises an encoded value generated by the system.

6. The system of claim 1, wherein modifying the one or more claim data elements comprises inserting a claim-level indicator recognized by the claims adjudication system.

7. The system of claim 1, wherein evaluating the electronic claim data comprises verifying that a submitting provider and a billed procedure code satisfy the service access constraints.

8. The system of claim 1, wherein the adjudication control information causes the claims adjudication system to bypass deductible, copayment, or coinsurance logic.

9. The system of claim 1, wherein transmitting the electronic claim data comprises transmitting the electronic claim data to either a clearinghouse system or directly to the claims adjudication system.

10. The system of claim 1, wherein the claims adjudication system, independent of the computer-implemented system, adjudicates the electronic claim data using contracted reimbursement rates associated with an individual's primary insurance plan.

11. A computer-implemented method comprising:
receiving electronic claim data corresponding to healthcare services rendered to an individual;
evaluating the electronic claim data against a set of pre-established service access constraints associated with the individual, the service access constraints defining conditions under which the individual is treated as having satisfied a financial responsibility requirement for at least a portion of the healthcare services;
classifying the electronic claim data as satisfying or not satisfying the service access constraints;
in response to classifying the electronic claim data as satisfying the service access constraints, generating adjudication control information that, when processed by a claims adjudication system distinct from the method, causes the claims adjudication system to adjudicate the electronic claim data without applying one or more patient-responsibility cost-sharing rules;
modifying one or more claim data elements associated with the electronic claim data based on the adjudication control information; and
transmitting the electronic claim data including the modified claim data elements to the claims adjudication system, and, in response to classifying the electronic claim data as not satisfying the service access constraints, transmitting the electronic claim data without adjudication control information.

12. The method of claim 11, wherein the service access constraints correspond to prepaid access to healthcare services selected prior to delivery of the healthcare services.

13. The method of claim 11, wherein evaluating the electronic claim data comprises verifying provider eligibility, service eligibility, and a validity period defined by the service access constraints.

14. The method of claim 11, wherein modifying the one or more claim data elements comprises inserting a claim-level indicator interpreted by the claims adjudication system.

15. The method of claim 11, wherein the adjudication control information causes the claims adjudication system to bypass deductible, copayment, or coinsurance logic.

16. A non-transitory computer-readable medium storing instructions that, when executed by one or more processors, cause the processors to perform operations comprising:
receiving electronic claim data corresponding to healthcare services rendered to an individual;
evaluating the electronic claim data against a set of pre-established service access constraints associated with the individual;
classifying the electronic claim data as satisfying or not satisfying the service access constraints;
in response to classifying the electronic claim data as satisfying the service access constraints, generating adjudication control information that causes a claims adjudication system distinct from the processors to adjudicate the electronic claim data without applying one or more patient-responsibility cost-sharing rules;
modifying one or more claim data elements based on the adjudication control information; and
transmitting the electronic claim data including the modified claim data elements for adjudication.

17. The computer-readable medium of claim 16, wherein the service access constraints correspond to prepaid access to healthcare services selected prior to delivery of the healthcare services.

18. The computer-readable medium of claim 16, wherein the service access constraints are associated with an access identifier included in the electronic claim data.

19. The computer-readable medium of claim 18, wherein the access identifier comprises an encoded value generated by the instructions.

20. The computer-readable medium of claim 16, wherein the adjudication control information causes the claims adjudication system to bypass deductible, copayment, or coinsurance logic.
